(19) United States
(12) Patent Application Publication
(10) Pub. No.: US 2006/0262044 A1
(43) Pub. Date: Nov. 23, 2006

(54) Plasma display apparatus and driving method thereof

(75) Inventors: Sung Im Lee, Gumi-si (KR); Won Jae Kim, Masan-si (KR); Wonsik Yoon, Gumi-si (KR); Yoonchang Choi, Milyang-si (KR); Hyun Lark Do, Buk-gu (KR)

Correspondence Address: FLESHNER & KIM, LLP, P.O. BOX 221200, CHANTILLY, VA, 20153, US

(73) Assignee: LG Electronics Inc.

(21) Appl. No.: 11/265,157

(22) Filed: Nov. 3, 2005

(30) Foreign Application Priority Data
May 20, 2005 (KR) 10-2005-0042716
May 23, 2005 (KR) 10-2005-0043297
May 23, 2005 (KR) 10-2005-0043298

(51) Int. Cl. G09G 3/28

(52) U.S. Cl. 345/68

(57) ABSTRACT

There is provided a plasma display apparatus and a driving method thereof. The plasma display apparatus includes a plasma display panel; and a scan driver commonly using a voltage source supplying a sustain pulse voltage, a setup bias voltage, a setdown pulse voltage, and a scan pulse voltage among a plurality of driving voltages supplied to a scan electrode of the plasma display panel.

This Nonprovisional application claims priority under 35 U.S.C. §119(a) on Korean Patent Application No. 10-2005-0042716 filed on May 20, 2005 and Korean Patent Application Nos. 10-2005-0043297 and 10-2005-0043298 filed in Korea on May 23, 2005, the entire contents of which are hereby incorporated by reference.

### BACKGROUND OF THE INVENTION

1. Field of the Invention

The present invention relates to a plasma display apparatus and a driving method thereof.

2. Description of the Background Art

Generally, plasma display panels (Hereinafter, referred to as “PDP”) display an image by exciting a phosphor and emitting light using ultraviolet rays generated when an inert mixture gas such as He+Xe, Ne+Xe, or He+Ne+Xe is discharged. Such PDPs can be easily manufactured using thin film, in large sizes and have been improved in an image quality as a result of recent technology developments.

FIG. 1 is a diagram illustrating a subfield pattern of an 8 bit default code for embodying 256 gray scales in the PDP.

Referring to FIG. 1, to embody a gray scale of an image, in the PDP, one frame is divided into several subfields comprising the number of different light emitting and the PDP is driven in a time division manner. Each subfield is divided into a reset period for initializing an entire screen, an address period for selecting a discharge cell, and a sustain period for embodying a gray scale depending on the number of discharges. For example, when an image is displayed with 256 gray scales, a frame period (16.67 ms) corresponding to 1/60 second is divided into eight subfields (SF1 to SF8). As described above, each of the eight subfields (SF1 to SF8) is divided into a reset period (RP), an address period (AP), and a sustain period (SP). The reset period (RP) and the address period (AP) of each subfield are equal in each subfield, but the sustain period and the number of sustain pulses allocated to the sustain period is increased in a ratio of 2ⁿ (n=0, 1, 2, 3, 4, 5, 6, 7) in each subfield.

FIG. 2 is a diagram illustrating a driving waveform of a general PDP.

Referring to FIG. 2, each subfield (SF) comprises a reset period (RP) for initializing discharge cells of an entire screen, an address period (AP) for selecting the discharge cell, and a sustain period (SP) for sustaining the discharge of the selected discharge cells.

In a setup period (SU) of the reset period (RP), ramp-up waveforms (PR) are simultaneously applied to all scan electrodes (Y). A weak discharge (setup discharge) occurs within cells of the entire screen by the ramp-up waveform (PR) and thus wall charges are generated within the cells. In a setdown period (SD), after the ramp-up waveform (PR) is applied, ramp-down waveforms. (NR) falling to a predetermined slope from a positive polarity of sustain voltage (Vs) lower than a peak voltage (Vs+Vr) of the ramp-up waveform (PR) to a negative polarity of scan voltage (−Vy) are simultaneously applied to the scan electrodes (Y). As the ramp-down waveform (NR) causes a weak erasing discharge within the cells, unnecessary charges among wall charges and space charges generated by the setup discharge are erased, whereby the wall charges required for address discharge uniformly remain within the cells of the entire screen.

In the address period (AP), when a negative polarity of scan pulse (SCNP) is sequentially applied to the scan electrodes (Y), a positive polarity of data pulse (DP) is simultaneously applied to the address electrodes. By adding a wall voltage generated in the reset period (RP) to the voltage difference of the scan pulse (SCNP) and the data pulse (DP), an address discharge occurs within the cell to which the data pulse (DP) is applied. Wall charges are generated within the cells selected by the address discharge.

The positive polarity (+) of sustain voltage (Vs) is applied to the sustain electrodes (Z) during the setdown period (SD) and the address period (AP).

In the sustain period (SP), the sustain pulse (SUSP) is alternatively applied to the scan electrodes (Y) and the sustain electrodes (Z). Then, as the sustain pulse (SUSP) and the wall voltage within the cell are added to the cell selected by the address discharge, whenever each of sustain pulses (SUSP) is applied, the sustain discharge occurs in a surface discharge manner between the scan electrodes (Y) and the sustain electrodes (Z). The sustain pulses (SUSP) have the same voltage value as the sustain voltage (Vs).

Among driving waveforms of such PDP, a scan driving waveform supplied to the scan electrodes Y is embodied by a scan driver of the PDP shown in FIG. 3.

FIG. 3 is a diagram illustrating a scan driver of a conventional PDP.

Referring to FIG. 3, a conventional scan driver comprises a sustain pulse/setup bias common voltage source (Vs), a sustain pulse/setup bias supplier 31, a setup ramp supplier 32, a setdown/scan voltage supplier 33, a scan reference voltage supplier 34, a scan integrated circuit (hereinafter, referred to as “IC”) 35, a first switch (S1), and a third switch (S3).

The sustain pulse/setup bias common voltage source (Vs) is a voltage source of a setup bias voltage (Vs) applied during the setup period (SU) and the sustain pulse (SUSP) applied during the sustain period (SP), to the scan electrodes (Y).

The sustain pulse/setup bias supplier 31 supplies the setup bias voltage (Vs) during the setup period (SU) and the sustain pulse (SUSP) during the sustain period (SP) to the scan electrodes (Y) by operating a plurality of switching elements using a voltage supplied from the sustain pulse/setup bias common voltage source (Vs).

The setup ramp supplier 32 comprises a setup ramp voltage source (Vr) and a second switch (S2). A negative polarity terminal of the setup ramp voltage source (Vr) is connected to the sustain pulse/setup bias supplier 31 and a positive polarity terminal of the setup ramp voltage source (Vr) is connected to the second switch (S2).

Setup ramp supplier 32 supplies the setup ramp voltage (Vr) to the first node (n1) by turning on the second switch (S2) when the setup bias voltage (Vs) is supplied to the first node (n1) through the first switch (S1) connected between the sustain pulse/setup bias supplier 31 and the second switch (S2) from the sustain pulse/setup bias supplier 31 during the setup period (SU). Therefore, a setup voltage (Vs+Vr) in which the setup ramp voltage (Vr) is added to the setup bias voltage (Vs) is supplied to the first node (n1).

The setdown/scan voltage supplier 33 comprises a setdown pulse/scan pulse voltage source (Vy), a fourth switch (S4), and a fifth switch (S5). A positive polarity terminal of the setdown pulse/scan pulse voltage source (Vy) is connected to the first node (n1) and a negative polarity terminal of the setdown pulse/scan pulse voltage source (Vy) is commonly connected to the fourth switch (S4) and the fifth switch (S5). Such setdown/scan voltage supplier 33 supplies a setdown pulse gradually falling to a setdown voltage (−Vy) to the second node (n2) through the fourth switch (S4) during the setdown period (SD) and supplies the negative polarity of scan pulse (SCNP) to the second node (n2) through the fifth switch (S5) during the address period (AP), to the scan electrodes (Y).

The scan reference voltage supplier 34 comprises a scan reference voltage source (Vsc) whose negative polarity terminal is connected to the second node (n2), a sixth switch (S6) whose one terminal is connected to a positive polarity terminal of the scan reference voltage source (Vsc), and a seventh switch (S7) whose one terminal is connected to the other terminal of the sixth switch (S6) and the other terminal is connected to the second node (n2). The sixth switch (S6) and the seventh switch (S7) are switched by a control signal supplied from a timing controller during the address period (AP) and supply a voltage of the scan reference voltage source (Vsc) to a scan IC 35 to be described later.

The scan IC 35 is connected in a push/pull manner and is composed of an eighth switch (S8) and a ninth switch (S9) supplying various driving signals supplied from the sustain pulse/setup bias supplier 31, the setup ramp supplier 32, the setdown/scan voltage supplier 33, the scan reference voltage supplier 34 to the scan electrodes (Y) An output line between the eighth switch (S8) and the ninth switch (S9) is connected to any one among the scan electrode lines.

As shown in FIG. 3, to embody a setup waveform, the scan driver of the conventional PDP separately uses three voltage sources of the sustain pulse/setup bias common voltage source (Vs) supplying the setup bias voltage, the setup ramp voltage source (Vr) supplying the setup ramp voltage, and the setdown pulse/scan pulse voltage source (Vy) supplying a setdown pulse voltage and a scan pulse voltage.

Given that the absolute values of a sustain pulse voltage, a setup bias voltage, a setup ramp voltage, a setdown pulse voltage, and a scan pulse voltage are the same and a voltage source is the need for highly priced component, there is a problem in that multiple voltage sources increases the manufacturing costs of a plasma display apparatus.

### SUMMARY OF THE INVENTION

Accordingly, an object of the present invention is to solve at least the problems and disadvantages of the background art.

An object of the present invention is to provide a plasma display apparatus which can reduce manufacturing costs by decreasing the number of a driving voltage source and a driving method thereof.

According to an aspect of the present invention, there is provided a plasma display apparatus comprising a plasma display panel; and a scan driver commonly using a voltage source supplying a sustain pulse voltage, a setup bias voltage, a setdown pulse voltage, and a scan pulse voltage among a plurality of driving voltages supplied to a scan electrode of the plasma display panel.

According to another aspect of the present invention, there is provided a plasma display apparatus comprising a plasma display panel; and a scan driver commonly using a voltage source supplying a sustain pulse voltage, a setup bias voltage, and a setup ramp voltage among a plurality of driving voltages supplied to a scan electrode of the plasma display panel.

According to still another aspect of the present invention, there is provided a method of driving a plasma display apparatus driven by dividing a plurality of subfields into a reset period, an address period, and a sustain period, the method comprises supplying a setup pulse gradually rising to a setup voltage having the same voltage level as the setup bias voltage after rapidly rising to the setup bias voltage during a setup period of the reset period to a scan electrode; and supplying a setdown pulse gradually falling from the setup bias voltage to a setdown voltage having the same absolute value as the setup bias voltage during a setdown period of the reset period to the scan electrode.

According to the present invention, it is possible to reduce the number of driving voltage sources by commonly using at least two voltage sources among voltage sources supplying the sustain pulse voltage, the setup bias voltage, the setup ramp voltage, the setdown pulse voltage, and the scan pulse voltage among the plurality of driving voltages supplied to the scan electrode of the plasma display panel and thus reduce the manufacturing costs.

### BRIEF DESCRIPTION OF TEE DRAWINGS

The invention will be described in detail with reference to the following drawings in which like numerals refer to like elements.

FIG. 1 is a diagram illustrating a subfield pattern of an 8 bit default code for embodying 256 gray scales in a PDP;

FIG. 2 is a diagram illustrating a driving waveform of a general PDP;

FIG. 3 is a diagram illustrating a scan driver of a conventional PDP;

FIG. 4 is a diagram illustrating a plasma display apparatus according to an embodiment of the present invention;

FIG. 5 is a diagram illustrating a scan driver according to an embodiment of the plasma display apparatus of the present invention;

FIG. 6 is a diagram illustrating a scan driver according to the other embodiment of the plasma display apparatus of the present invention;

FIG. 7 is a diagram illustrating a scan driver according to the other embodiment of the plasma display apparatus of the present invention; and

FIGS. 8, 9 and 10 are diagrams illustrating driving waveforms according to an embodiment of a plasma display panel of the present invention.

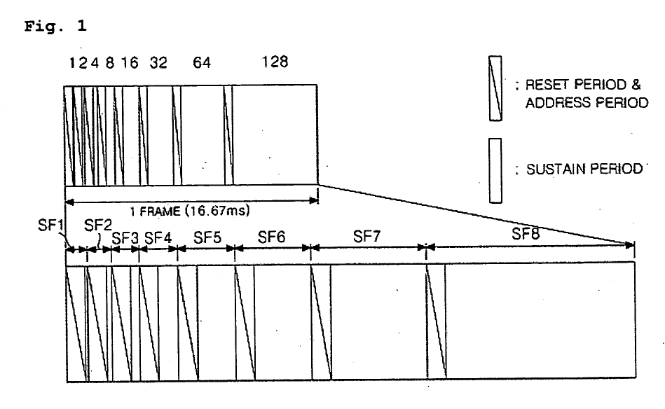

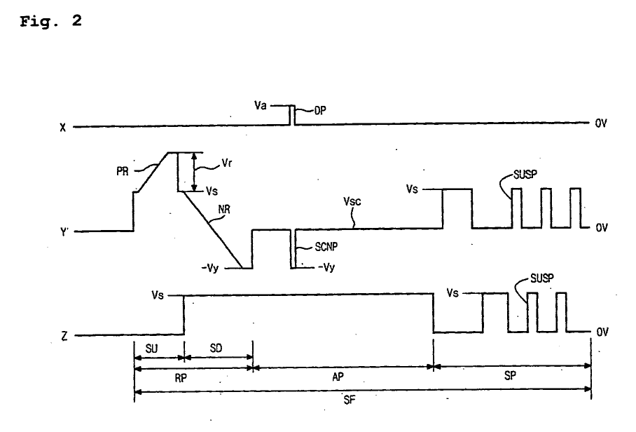

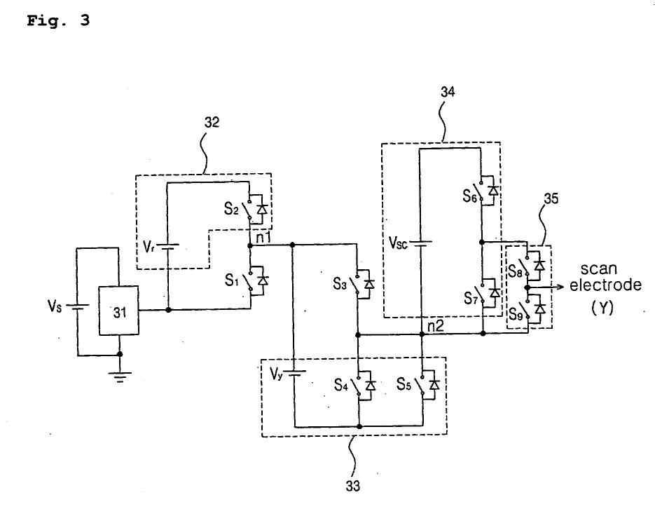

### DETAILED DESCRIPTION OF PREFERRED EMBODIMENTS

Preferred embodiments of the present invention will be described in a more detailed manner with reference to the drawings.

According to an aspect of the present invention, there is provided a plasma display apparatus comprising: a plasma display panel having a scan electrode; and a scan driver having a common voltage source commonly using all of a setup bias voltage and a setdown pulse voltage applied during a reset period, a scan pulse voltage applied during an address period, and a sustain pulse voltage applied during a sustain period to the scan electrode.

The scan driver may comprise the common voltage source having one grounded terminal; a sustain pulse/setup bias supplier connected between the common voltage source and the scan electrode to supply the sustain pulse voltage and the setup bias voltage to the scan electrode; a setdown pulse/scan pulse supplier connected between the sustain pulse/setup bias supplier and the scan electrode to supply the setdown pulse voltage and the scan pulse voltage to the scan electrode; and a first switch provided between the sustain pulse/setup bias supplier and the setdown pulse/scan pulse supplier.

A first terminal of the sustain pulse/setup bias supplier is commonly connected to negative polarity terminals of a ground voltage source and the sustain pulse/setup bias/setdown pulse/scan pulse common voltage source, a second terminal of the sustain pulse/setup bias supplier is connected to a positive polarity terminal of the sustain pulse/setup bias/setdown pulse/scan pulse common voltage source, and a third terminal of the sustain pulse/setup bias supplier is connected to one terminal of the first switch.

The setdown pulse/scan pulse supplier comprise a first capacitor charged by receiving power from the common voltage source; a fourth switch converting a voltage charged in the first capacitor to the setdown pulse voltage and supplying the converted voltage to the scan electrode; and a fifth switch converting a voltage charged in the first capacitor to the scan pulse voltage and supplying the converted voltage to the scan electrode.

One terminal of the first capacitor connected to the other terminal of the first switch, and the other terminal of the first capacitor is connected to a negative terminal of the sustain pulse/setup bias/setdown pulse/scan pulse common voltage source.

One terminal of the fourth switch is commonly connected to the other terminal of the first capacitor, and the other terminal of the fourth switch is connected to the other terminal of the fifth switch.

The plasma display apparatus further comprises a inverse current preventing unit connected between the negative polarity terminal of the sustain pulse/setup bias/setdown pulse/scan pulse common voltage source and the other terminal of the first capacitor.

The inverse current preventing unit comprises a first diode, an anode terminal of the first diode is connected to the other terminal of the first capacitor, and a cathode terminal of the first diode is connected to the negative terminal of the sustain pulse/setup bias/setdown pulse/scan pulse common voltage source.

The common voltage source is further generate a setup ramp voltage supplied to the scan electrode.

According to another aspect of the present invention, there is provided a plasma display apparatus comprising: a plasma display panel having a scan electrode; and a scan driver having a common voltage source commonly using all of a setup bias voltage and a setup ramp voltage applied during a reset period and a sustain pulse voltage applied during a sustain period, to the scan electrode.

The scan driver comprises the common voltage source having one grounded terminal; a sustain pulse/setup bias supplier connected between the common voltage source and the scan electrode to supply the sustain pulse voltage and the setup bias voltage to the scan electrode; a setup ramp supplier connected between the sustain pulse/setup bias supplier and the scan electrode to supply the setup ramp voltage to the scan electrode; and a first switch connected between the sustain pulse/setup bias supplier and the scan electrode.

A first terminal of the sustain pulse/setup bias supplier is commonly connected to negative polarity terminals of a ground voltage source and the sustain pulse/setup bias/setup ramp common voltage source, a second terminal of the sustain pulse/setup bias supplier be commonly connected to a positive polarity terminal of the sustain pulse/setup bias/setup ramp common voltage source and the first terminal of the setup ramp supplier, and a third terminal of the sustain pulse/setup bias supplier is commonly connected to the second terminal of the setup ramp supplier and one terminal of the first switch.

The setup ramp supplier comprises a first capacitor charged by receiving power from the sustain pulse/setup bias/setup ramp common voltage source; and a second switch converting the voltage charged in the first capacitor to the setup ramp voltage and supplying the converted voltage to the scan electrode.

One terminal of the first capacitor is commonly connected to the positive polarity terminal of the sustain pulse/setup bias/setup ramp common voltage source and a second terminal of the sustain pulse/setup bias supplier, and the other terminal of the first capacitor is commonly connected to a third terminal of the sustain pulse/setup bias supplier and the one terminal of the first switch.

One terminal of the second switch is commonly connected to the positive polarity terminal of the sustain pulse/setup bias/setup ramp common voltage source, the second terminal of the sustain pulse/setup bias supplier, and the one terminal of the first capacitor, and the other terminal of the second switch is connected to the other terminal of the first switch.

The plasma display apparatus further comprises a inverse current preventing unit connected between the positive polarity terminal of the sustain pulse/setup bias/setup ramp common voltage source and the one terminal of the first capacitor.

The inverse current preventing unit comprises a first diode, an anode terminal of the first diode is connected to the positive polarity terminal of the sustain pulse/setup bias/setup ramp common voltage source and a cathode terminal of the first diode is connected to one terminal of the first cathode.

According to still another aspect of the present invention, there is provided a method of driving a plasma display apparatus driven by dividing a plurality of subfields into a reset period, an address period, and a sustain period, the method comprising: supplying a setup pulse gradually rising to a setup voltage having the same voltage level as the setup bias voltage after rapidly rising to the setup bias voltage during a setup period of the reset period to a scan electrode; and supplying a setdown pulse gradually falling from the setup bias voltage to a setdown voltage having the same absolute value as the setup bias voltage during a setdown period of the reset period to the scan electrode.

An absolute voltage value of the scan pulse applied to the scan electrode is equal with the setup bias voltage level during the address period.

A voltage of the sustain pulse applied to the scan electrode or the sustain electrode is equal with the setup bias voltage level during the sustain period.

Hereinafter, a plasma display apparatus and a driving method thereof according to the present invention will be described in detail with reference to the accompanying drawings.

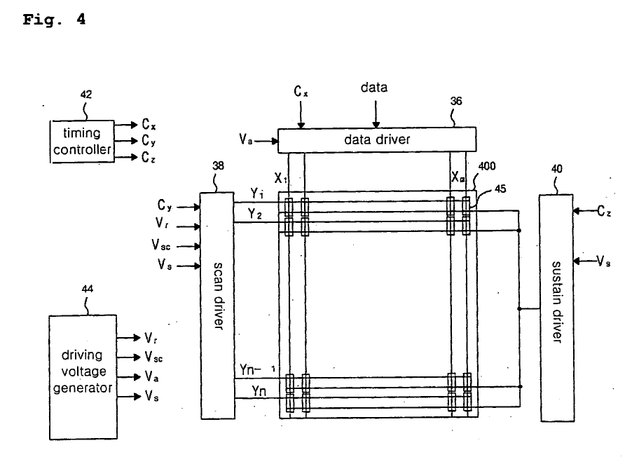

FIG. 4 is a diagram illustrating a plasma display apparatus according to an embodiment of the present invention.

As shown in FIG. 4, the plasma display apparatus according to the embodiment of the present invention comprises a PDP 400 for displaying an image, a data driver 36 for supplying data to address electrodes (X1 to Xm), a scan driver 38 for driving scan electrodes (Y1 to Yn), a sustain driver 40 for driving sustain electrodes (Z), a timing controller 42 for controlling the respective drivers 36, 38 and 40, and a driving voltage generating unit 44 for supplying a driving voltage required for the respective drivers 36, 38 and 40.

In the plasma display apparatus, one frame is composed of a plurality of subfields and the plurality of subfields are driven by dividing into a reset period, an address period, and a sustain period.

The PDP 400 is composed of an upper plate having the scan electrodes (Y1 to Yn) and the sustain electrodes (Z) and a lower plate having the address electrodes (X1 to Xm). In the upper plate, a upper dielectric layer (not shown) for accumulating wall charges and a protective film (not shown) for protecting the damage of the upper dielectric layer by sputtering when a plasma is discharged are stacked on the scan electrodes (Y1 to Yn) and the sustain electrodes (Z). In the lower plate, a lower dielectric layer (not shown) for accumulating wall charges is formed in a lower part of the address electrodes (X1 to Xm). In the PDP 400, discharge cells 45 are formed in intersections of the scan electrodes (Y1 to Yn), the sustain electrodes (Z), and the address electrodes (X1 to Xm). The respective discharge cells 45 are separated by a barrier rib (not shown) formed in the lower plate and the inside thereof is coated with red color, green color, and blue color phosphors.

In the PDP 400, the discharge cells 45 are selected by the data pulse (DP) and the scan pulse (SCNP) supplied to the address electrodes (X1 to Xm) and the scan electrodes (Y1 to Yn), and sustain discharge is maintained by the sustain pulse (SUSP) supplied to the scan electrodes (Y1 to Yn) and the sustain electrodes (Z). Accordingly, in the discharge cells 45, the phosphor coated at the inside of the discharge cells 45 emits light by ultraviolet rays generated when the sustain discharge is performed and thus visible rays are emitted, so that an image is displayed.

The data driver 36 samples and latches data in response to a timing control signal (Cx) supplied from the timing controller 42 and then, supplies a data voltage (Va) to the address electrodes (X1 to Xm).

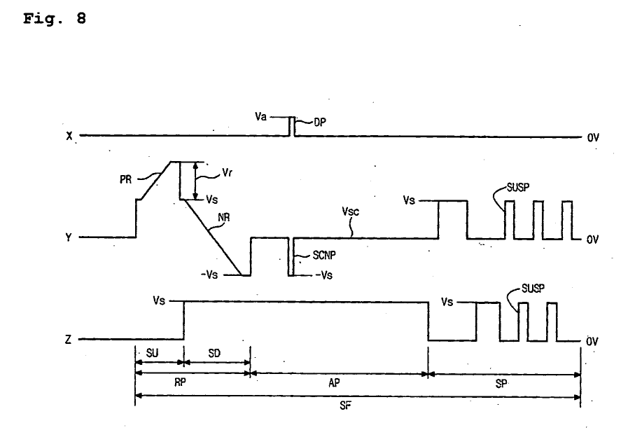

The scan driver 38 supplies driving waveforms to the scan electrodes in various forms as shown in FIGS. 8 to 10.

As shown in FIG. 8, the scan driver 38 supplies reset pulses (PR, NR) including a setdown pulse (NR) gradually falling from a setup bias voltage (Vs) to a setdown voltage (−Vs) and a setup pulse (PR) gradually rising to a setup voltage (Vs+Vr) as a setup ramp voltage (Vr) is added to the scan bias voltage (Vs) after rapidly rising from a ground voltage to a scan bias voltage (Vs) to the scan electrodes (Y1 to Yn).

During an address period (AP), the scan driver 38 supplies a scan reference voltage (Vsc) to the scan electrodes (Y1 to Yn) and sequentially supplies a scan pulse (SCNP) having a negative polarity of scan voltage (−Vy) value to the scan electrodes (Y1 to Yn).

During the sustain period (SP), the scan driver 38 supplies the sustain pulse (SUSP) having the sustain voltage level (Vs) and the ground voltage level (GND) to the scan electrodes (Y1 to Yn).

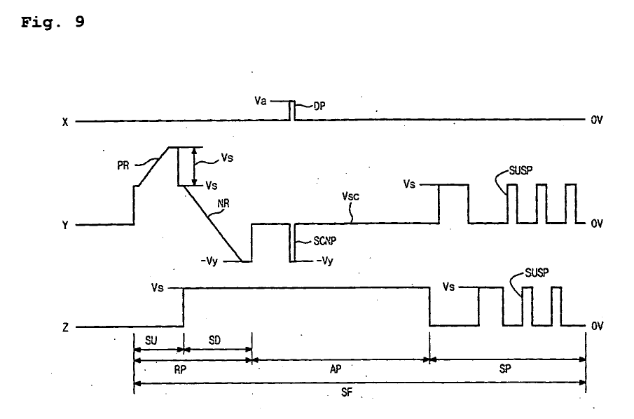

As shown in FIG. 9, the scan driver 38 supplies reset pulses (PR, NR) including a setup pulse (PR) gradually rising to a setup voltage (2Vs) after rapidly rising from a ground voltage to the setup bias voltage (Vs) during the reset period (RP) in response to a timing control signal (Cy) supplied from the timing controller 42 to the scan electrodes (Y1 to Yn).

During an address period (AP), the scan driver 38 supplies the scan reference voltage (Vsc) to the scan electrodes (Y1 to Yn) and sequentially supplies a scan pulse (SCNP) having a negative polarity of scan voltage (−Vy) value to the scan electrodes (Y1 to Yn).

During the sustain period (SP), the scan driver 38 supplies the sustain pulse (SUSP) having the sustain voltage level (Vs) and the ground voltage level (GND) to the scan electrodes (Y1 to Yn).

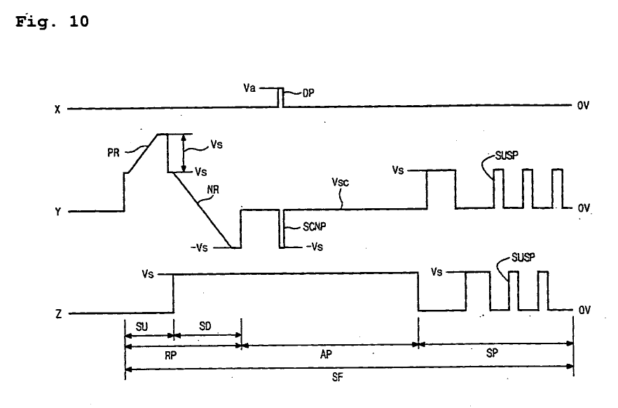

As shown in FIG. 10, the scan driver 38 supplies reset pulses (PR, NR) including a setdown pulse (NR) gradually falling from a setup bias voltage (Vs) to a setdown voltage (−Vs) and a setup pulse (PR) gradually rising to a setup voltage (2Vs) after rapidly rising from a ground voltage to the setup bias voltage (Vs) during the reset period (RP) in response to a timing control signal (Cy) supplied from the timing controller 42 to the scan electrodes (Y1 to Yn).

During an address period (AP), the scan driver 38 supplies a scan reference voltage (Vsc) to the scan electrodes (Y1 to Yn) and sequentially supplies a scan pulse (SCNP) having a negative polarity of scan pulse voltage (−Vy) value to the scan electrodes (Y1 to Yn).

During the sustain period (SP), the scan driver 38 supplies the sustain pulse (SUSP) having the sustain voltage level (Vs) and the ground voltage level (GND) to the scan electrodes (Y1 to Yn).

The sustain driver 40 supplies the sustain pulse (SUSP) having the sustain voltage level (Vs) and the ground voltage level (GND) to the sustain electrodes (Z) by alternately operating with the scan driver 38 during the sustain period (SP) after supplying a positive polarity of sustain voltage (Vs) to the sustain electrodes (Z) during the setdown period (SD) and the address period (AP) in response to a timing control signal (Cz) supplied from the timing controller 42.

The timing controller 42 receives vertical/horizontal synchronous signals and a clock signal and generates the timing control signals (Cx, Cy, Cz) required for the respective drivers 36, 38 and 40 and controls the respective drivers 36, 38 and 40 by supplying the timing control signals (Cx, Cy, Cz) to the corresponding drivers 36, 38 and 40. A sampling clock for sampling data, a latch control signal, and a switch control signal for controlling on/off time of a driving switch element are included in the timing control signal (Cx). A switch control signal for controlling the on/off time of the driving switch element within the scan driver 38 is included in the timing control signal (Cy). A switch control signal for controlling the on/off time of a driving switch element within the sustain driver 40 is included in the timing control signal (Cz).

The driving voltage generating unit 44 generates a sustain pulse/setup bias/setdown pulse/scan pulse common voltage (Vs), a setup ramp voltage (Vr), a DC scan reference voltage (Vsc), a data voltage (Va), etc. and supplies them to the data driver 36, the scan driver 38, and the sustain driver 40.

Hereinafter, the scan driver 38 of the plasma display apparatus according to the present invention will be described in detail.

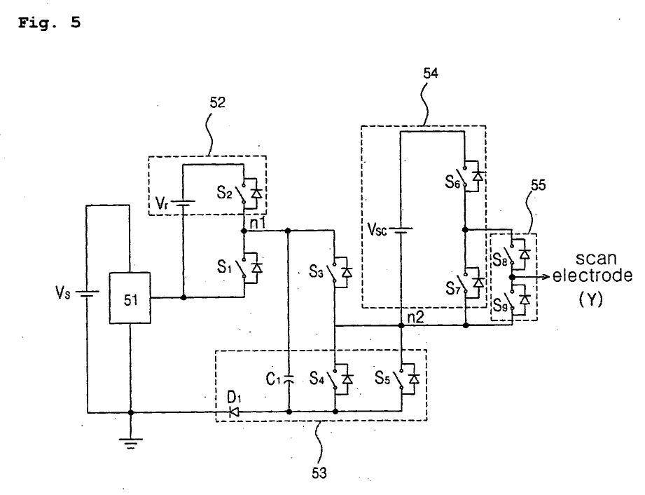

FIG. 5 is a diagram illustrating the scan driver 38 according to an embodiment of the plasma display apparatus of the present invention.

As shown in FIG. 5, the scan driver 38 of the plasma display apparatus according to the present invention comprises a sustain pulse/setup bias/setdown pulse/scan pulse common voltage source (Vs) having one grounded terminal, a sustain pulse/setup bias supplier, 51 connected between the sustain pulse/setup bias/setdown pulse/scan pulse common voltage source (Vs) and the scan electrode (Y), a setup ramp supplier 52 connected between the sustain pulse/setup bias supplier 51 and the scan electrode (Y), a first switch (S1) connected between the sustain pulse/setup bias supplier 51 and the scan electrode (Y), a third switch (S3) and a setdown pulse/scan pulse supplier 53 connected between the first switch (S1) and the scan electrode (Y), a scan reference voltage supplier 54 connected between the setdown pulse/scan pulse supplier 53 and the scan electrode (Y), and a scan IC 55 connected between the scan reference voltage supplier 54 and the scan electrode (Y).

The sustain pulse/setup bias/setdown pulse/scan pulse common voltage source (Vs) is a voltage source of the setup bias voltage (Vs) applied during the setup period (SU), a setdown pulse voltage (−Vs) applied during a setdown period (SD), a scan pulse voltage (−Vs) applied during the address period (AD), and the sustain pulse voltage (Vs) applied during the sustain period (SP), to the scan electrodes (Y).

A first terminal of the sustain pulse/setup bias supplier 51 is commonly connected to negative polarity terminals of a ground voltage source and the sustain pulse/setup bias/setdown pulse/scan pulse common voltage source (Vs), a second terminal of the sustain pulse/setup bias supplier 51 is connected to a positive polarity-terminal of the sustain pulse/setup bias/setdown pulse/scan pulse common voltage source (Vs), and a third terminal of the sustain pulse/setup bias supplier 51 is connected to one terminal of the first switch (S1).

The sustain pulse/setup bias supplier 51 supplies the setup bias voltage (Vs) during the setup period (SU) and the sustain pulse voltage (Vs) during the sustain period (SP) to the scan electrodes (Y) by operating a plurality of switching elements using a voltage supplied from the sustain pulse/setup bias/setdown pulse/scan pulse common voltage source (Vs).

The setup ramp supplier 52 comprises a setup ramp voltage source (Vr) and a second switch (S2). A positive polarity terminal of the setup ramp voltage source (Vr) is connected to one terminal of the second switch (S2), a negative polarity terminal of the setup ramp voltage source (Vr) is commonly connected to the third terminal of the sustain pulse/setup bias supplier 51 and the one terminal of the first switch (S1), and the other terminal of the first switch (S1) is connected to the other terminal of the second switch (S2). If the setup ramp supplier 52 supplies a setup bias voltage (Vs) from the sustain pulse/setup bias supplier 51 to a first node (n1) that is a connection point of the first switch (S1) and the second switch (S2) during the setup period (SU), it converts a voltage received from the setup ramp voltage source (Vr) to the setup ramp voltage source (Vr) gradually rising by turning on the second switch (S2) and supplies the converted voltage to the first node (n1). As a result, a setup voltage in which the setup bias voltage (Vs) is added to the setup ramp voltage is supplied to the first node (n1).

A field effect diode (FET) as the second switch (S2) that is a means for embodying the setup ramp voltage is selected and a method of connecting a variable resistance to a gate terminal of the second switch (S2) is considered.

The setdown pulse/scan pulse supplier 53 comprises a first capacitor (C1) charged by receiving power from the sustain pulse/setup bias/setdown pulse/scan pulse common voltage source (Vs), a fourth switch (S4) for converting a voltage charged in the first capacitor (C1) to a setdown pulse voltage gradually falling and supplying the converted voltage to the scan electrode (Y), and a fifth switch (S5) for using the voltage charged in the first capacitor (C1) to supply the scan pulse voltage to the scan electrode (Y).

One terminal of the first capacitor (C1) is connected to the other terminal of the first switch (S1) and the other terminal of the first capacitor (C1) is connected to the negative polarity terminal of the sustain pulse/setup bias/setdown pulse/scan pulse common voltage source (Vs). One terminal of the fourth switch (S4) and one terminal of the fifth switch (S5) are commonly connected to the other terminal of the first capacitor (C1) and the other terminal of the fourth switch (S4) is connected to the other terminal of the fifth switch (S5).

An operation principle of the setdown pulse/scan pulse supplier 53 will be described in detail.

If the second and third terminals of the sustain pulse/setup bias supplier 51 are electrically connected through a switching operation within the sustain pulse/setup bias supplier 51 during the setdown period (SD) to form a network connecting the sustain pulse/setup bias/setdown pulse/scan pulse common voltage source (Vs), an inner diode of the first switch (S1), the first capacitor (C1), and the sustain pulse/setup bias/setdown pulse/scan pulse common voltage source (Vs), both terminals of the first capacitor (C1) are charged to a Vs level.

After both terminals of the first capacitor (C1) are charged to the Vs level, one terminal thereof turns on the fourth switch (S4) connected to the other terminal of the first capacitor (C1), that is, the negative polarity terminal of the first capacitor (C1).

If the fourth switch (S4) is turned on, a voltage of the Vs level charged in the first capacitor (C1) is converted to the setdown pulse voltage gradually falling by the fourth switch (S4) and the converted voltage is supplied to a second node (n2). A field effect diode (FET) as the fourth switch (S4) that is means embodying the setdown pulse voltage is selected and a method of connecting a variable resistance to a gate terminal of the fourth switch (S4) may be considered.

If the fifth switch (S5) is turned on during the address period (AP), the scan pulse voltage of −Vs level is supplied to the second node through the fifth switch (S5).

It is preferable that the setdown pulse/scan pulse supplier 53 further comprises a inverse current preventing unit connected between the negative polarity terminal of the sustain pulse/setup bias/setdown pulse/scan pulse common voltage source (Vs) and the other terminal of the first capacitor (C1).

The inverse current preventing unit comprises a first diode (D1) and an anode terminal of the first diode (D1) is connected to the other terminal of the first capacitor (C1) and the cathode terminal of the first diode (D1) is connected to the negative polarity terminal of the sustain pulse/setup bias/setdown pulse/scan pulse common voltage source (Vs), so that an inverse current can be prevented from flowing.

The scan reference voltage supplier 54 comprises a scan reference voltage source (Vsc) whose a negative polarity terminal is connected to the second node (n2), a sixth switch (S6) whose one terminal is connected to a positive polarity terminal of the scan reference voltage source (Vsc), and a seventh switch (S7) whose one terminal is connected to the other terminal of the sixth switch (S6) and whose the other terminal is connected to the second node (n2). The sixth switch (S6) and the seventh switch (S7) are switched by a control signal supplied from the timing controller during the address period (AP) and supply a voltage of the scan reference voltage source (Vsc) to a scan IC 55 to be described later.

The scan IC 55 is connected in a push/pull manner and is composed of the sustain pulse/setup bias supplier 51, the setup ramp supplier 52, the setdown/scan voltage supplier 53, and an eighth switch (S8) and a ninth switch (S9) which supply various driving signals supplied from the scan reference voltage supplier 54 to the scan electrodes (Y). An output line between the eighth switch (S8) and the ninth switch (S9) is connected to any one among the scan electrode lines.

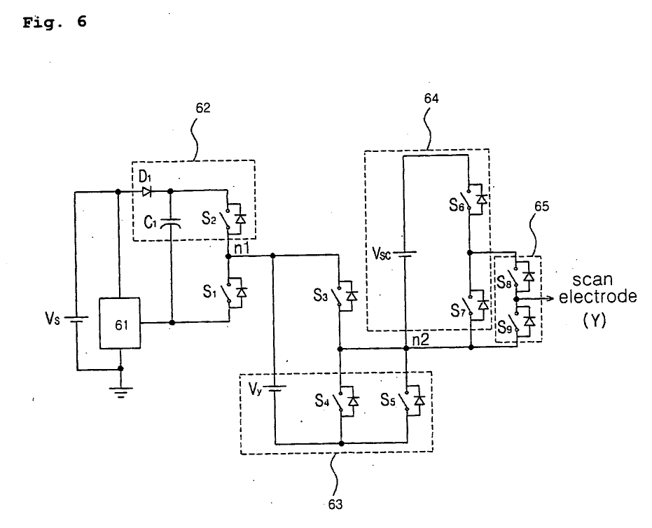

FIG. 6 is a diagram illustrating another scan driver 38 according to an embodiment of the plasma display apparatus of the present invention.

As shown in FIG. 6, the scan driver 38 of the plasma display apparatus according to the present invention comprises a sustain pulse/setup bias/setup ramp common voltage source (Vs) having one grounded terminal, a sustain pulse/setup bias supplier 61 connected between the sustain pulse/setup bias/setup ramp common voltage source (Vs) and the scan electrode (Y), a setup ramp supplier 62 connected between the sustain pulse/setup bias supplier 61 and the scan electrode (Y), a first switch (S1) connected between the sustain pulse/setup bias supplier 61 and the scan electrode (Y), a setdown pulse/scan pulse supplier 53 and a third switch (S3) connected between the first switch (S1) and the scan electrode (Y), a scan reference voltage supplier 64 connected between the setdown pulse/scan pulse supplier 63 and the scan electrode (Y), and a scan IC 65 connected between the scan reference voltage supplier 64 and the scan electrode (Y).

The sustain pulse/setup bias/setup ramp common voltage source (Vs) is a voltage source of the setup bias voltage (Vs) and the setup ramp voltage (Vs) applied during the setup period (SU) and the sustain pulse voltage (Vs) applied during the sustain period (SP), to the scan electrodes (Y).

A first terminal of the sustain pulse/setup bias supplier 61 is commonly connected to negative polarity terminals of a ground voltage source and the sustain pulse/setup bias common voltage source (Vs), a second terminal of the sustain pulse/setup bias supplier 61 is commonly connected to a positive polarity terminal of the sustain pulse/setup bias common voltage source (Vs) and a first terminal of the setup ramp supplier 62 to be described later, and a third terminal of the sustain pulse/setup bias supplier 61 is commonly connected to a second terminal of the setup ramp supplier 62 to be described later and one terminal of the first switch (S1).

The sustain pulse/setup bias supplier 61 supplies the setup voltage (2Vs) including the setup bias voltage (Vs) and the setup ramp voltage (Vs) during the setup period (SU) and supplies the sustain pulse (SUSP) during the sustain period (SP) to the scan electrodes (Y) by operating a plurality of switching elements using a voltage supplied from the sustain pulse/setup bias/setup ramp common voltage-source (Vs).

The setup ramp supplier 62 comprises a first capacitor (C1) charged by from the sustain pulse/setup bias/setup ramp common voltage source (Vs) and a second switch (S2) for converting a voltage charged in the first capacitor (C1) to the gradually rising setup ramp voltage and supplying the converted voltage to the scan electrode (Y).

One terminal of the first capacitor (C1) is commonly connected to the positive polarity terminal of the sustain pulse/setup bias/setup ramp common voltage source (Vs) and the second terminal of the sustain pulse/setup bias supplier 61 and the other terminal of the first capacitor (C1) is commonly connected to the third terminal of the sustain pulse/setup bias supplier 61 and the one terminal of the first switch (S1).

One terminal of the second switch (S2) is commonly connected to the positive polarity terminal of the sustain pulse/setup bias/setup ramp common voltage source (Vs), the second terminal of the sustain pulse/setup bias supplier 61, and one terminal of the first capacitor (C1) and the other terminal of the second switch (S2) is connected to the other terminal of the first switch (S1).

An operation principle of the setup ramp supplier 62 will be described in detail.

If the first and third terminals of the sustain pulse/setup bias supplier 61 are electrically connected to each other through a switching operation within the sustain pulse/setup bias supplier 61 during the setup period (SU) to form a network connecting the sustain pulse/setup bias/setup ramp common voltage source (Vs), the first capacitor (C1), a ground voltage source, and the sustain pulse/setup bias/setup ramp common voltage source (Vs), both terminals of the first capacitor (C1) are charged to a Vs level. Next, if the second and third terminals of the sustain pulse/setup bias supplier 61 are electrically connected to each other through a switching operation within the sustain pulse/setup bias supplier 61 and thus the setup bias voltage (Vs) is supplied to a first node (n1) through an inner diode of the first switch (S1) and the third terminal of the sustain pulse/setup bias supplier 61, the second switch (S2) is turned on. If the second switch (S2) is turned on, a voltage of Vs level charged in the first capacitor (C1) is converted to the gradually rising setup ramp voltage by the second switch (S2) and the converted voltage is supplied to the first node (n1). As a result, a setup voltage to which the setup bias voltage and the setup ramp voltage are added is supplied to the first node (n1).

A field effect diode (FET) as the second switch (S2) that is a means for embodying the setup ramp voltage may be selected and a method of connecting a variable resistance to a gate terminal of the second switch (S2) may be considered.

It is preferable that the setup ramp supplier 62 further comprises the first diode (D1) connected between the one terminal of the first capacitor (C1) and the positive polarity terminal of the sustain pulse/setup bias/setup ramp common voltage source (Vs).

By connecting an anode terminal of the first diode (D1) to the positive polarity terminal of the sustain pulse/setup bias/setup ramp common voltage source (Vs) and a cathode terminal of the first diode (D1) to the one terminal of the first capacitor (C1), it is possible to intercept an inverse current from flowing from one terminal of the first capacitor (C1) to the positive polarity terminal of the sustain pulse/setup bias/setup ramp common voltage source (Vs).

The setdown pulse/scan pulse supplier 63 comprises a setdown pulse/scan pulse voltage source (Vy), a fourth switch (S4), and a fifth switch (S5). The positive polarity terminal of the setdown pulse/scan pulse voltage source (Vy) is connected to the first node (n1) and the negative polarity terminal of the setdown pulse/scan pulse voltage source (Vy) is commonly connected to the fourth switch (S4) and the fifth switch (S5). The setdown pulse/scan pulse supplier 63 supplies the setdown pulses gradually falling to the setdown voltage (−Vy) to the second node (n2) through the fourth switch (S4) during the setdown period (SD) and supplies the negative polarity of scan pulse (SCNP) to the second node (n2) through the fifth switch (S5) during the address period (AP), to the scan electrodes (Y).

The scan reference voltage supplier 64 comprises a scan reference voltage source (Vsc) whose the negative polarity terminal is connected to the second node (n2), a sixth switch (S6) whose one terminal is connected to the positive polarity terminal of the scan reference voltage source (Vsc), and a seventh switch (S7) whose one terminal is connected to the other terminal of the sixth switch (S6) and whose the other terminal is connected to the second node (n2). The sixth switch (S6) and the seventh switch (S7) are switched by a control signal supplied from the timing controller during the address period (AP) and supply a voltage of the scan reference voltage source (Vsc) to the scan IC 65 to be described later.

The scan IC 65 is connected in a push/pull manner and is composed of a sustain pulse/setup bias supplier 61, a setup ramp supplier 62, a setdown/scan voltage supplier 63, and an eighth switch (S8) and a ninth switch (S9) which supply various driving signals supplied from a scan reference voltage supplier 64 to the scan electrodes (Y). An output line between the eighth switch (S8) and the ninth switch (S9) is connected to any one among the scan electrode lines.

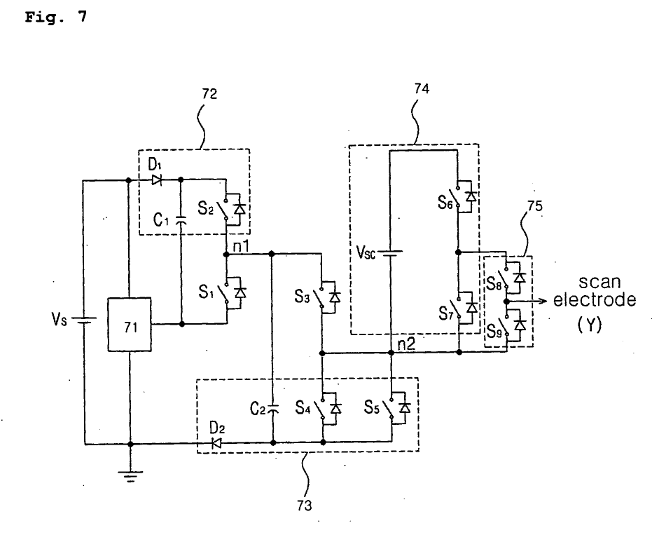

FIG. 7 is a diagram illustrating the other scan driver 38 according to an embodiment of the plasma display apparatus of the present invention.

As shown in FIG. 7, the scan driver 38 of the plasma display apparatus according to the present invention comprises a sustain pulse/setup bias/setup ramp/setdown pulse/scan pulse common voltage source (Vs) having one grounded terminal, a sustain pulse/setup bias supplier 71 connected between the sustain pulse/setup bias/setup ramp/setdown pulse/scan pulse common voltage source (Vs) and the scan electrode (Y), a setup ramp supplier 72 connected between the sustain pulse/setup bias supplier 71 and the scan electrode (Y), a setdown pulse/scan pulse supplier 73 connected between the sustain pulse/setup bias supplier 71 and the scan electrode (Y), a first switch (S1) connected between the sustain pulse/setup bias supplier 71 and the setdown pulse/scan pulse supplier 73, a third switch (S3) and a setdown pulse/scan pulse supplier 73 connected between the first switch (S1) and the scan electrode (Y), a scan reference voltage supplier 74 connected between the setdown pulse/scan pulse supplier 73 and the scan electrode (Y), and a scan IC 75 connected between the scan reference voltage supplier 74 and the scan electrode (Y).

The sustain pulse/setup bias/setup ramp/setdown pulse/scan pulse common voltage source (Vs) is a common voltage source of the setup bias voltage (Vs) and the setup ramp voltage (Vs) applied during a setup period (SU), a setdown pulse voltage (−Vs) applied during a setdown period (SD), a scan pulse voltage (−Vs) applied during the address period (AD), and the sustain pulse voltage (Vs) applied during the sustain period (SP), to the scan electrodes (Y).

A first terminal of the sustain pulse/setup bias supplier 71 is commonly connected to negative polarity terminals of a ground voltage source and the sustain pulse/setup bias/setup ramp/setdown pulse/scan pulse common voltage source (Vs), a second terminal of the sustain pulse/setup bias supplier 71 is commonly connected to a positive polarity terminal of the sustain pulse/setup bias/setup ramp/setdown pulse/scan pulse common voltage source (Vs) and a first terminal of a setup ramp supplier 72 to be described later, and a third terminal of the sustain pulse/setup bias supplier 71 is commonly connected to a second terminal of a setup ramp supplier 72 to be described later and one terminal of the first switch (S1).

The sustain pulse/setup bias supplier 71 supplies a setup voltage (2Vs) comprising the setup bias voltage (Vs) and the setup ramp voltage (Vs) during the setup period (SU) and the sustain pulse voltage (Vs) during the sustain period (SP) to the scan electrodes (Y) by operating a plurality of switching elements using a voltage supplied from the sustain pulse/setup bias/setup ramp/setdown pulse/scan pulse common voltage source (Vs).

The setup ramp supplier 72 comprises a first capacitor (C1) charged by from the sustain pulse/setup bias/setup ramp/setdown pulse/scan pulse common voltage source (Vs) and a second switch (S2) for converting a voltage charged in the first capacitor (C1) to the gradually rising setup ramp voltage and supplying the converted voltage to the scan electrode (Y).

One terminal of the first capacitor (C1) is commonly connected to the positive polarity terminal of the sustain pulse/setup bias/setup ramp/setdown pulse/scan pulse common voltage source (Vs) and the second terminal of the sustain pulse/setup bias supplier 71 and the other terminal of the first capacitor (C1) is commonly connected to the third terminal of the sustain pulse/setup bias supplier 71 and the one terminal of the first switch (S1).

One terminal of the second switch (S2) is commonly connected to the positive polarity terminal of the sustain pulse/setup bias/setup ramp/setdown pulse/scan pulse common voltage source (Vs), the second terminal of the sustain pulse/setup bias supplier 71, and the one terminal of the first capacitor (C1) and the other terminal of the second switch (S2) is connected to the other terminal of the first switch (S1).

An operation principle of the setup ramp supplier 72 will be described in detail.

If the first and third terminals of the sustain pulse/setup bias supplier 71 are electrically connected to each other through a switching operation within the sustain pulse/setup bias supplier 71 during the setup period (SU) to form a network connecting the sustain pulse/setup bias/setup ramp/setdown pulse/scan pulse common voltage source (Vs), the first capacitor (C1), the ground voltage source, and the sustain pulse/setup bias/setup ramp/setdown pulse/scan pulse common voltage source (Vs), both terminals of the first capacitor (C1) are charged to a Vs level.

If the second and third terminals of the sustain pulse/setup bias supplier 71 are electrically connected to each other through a switching operation within the sustain pulse/setup bias supplier 71 and thus the setup bias voltage (Vs) is supplied to a first node (n1) through an inner diode of the first switch (S1) and the third terminal of the sustain pulse/setup bias supplier 71, the second switch (S2) is turned on. If the second switch (S2) is turned on, a voltage of Vs level charged in the first capacitor (C1) is converted to the gradually rising setup ramp voltage by the second switch (S2) and the converted voltage is supplied to the first node (n1). As a result, a setup voltage to which the setup bias voltage and the setup ramp voltage are added is supplied to the first node (n1).

A field effect diode (FET) as the second switch (S2) that is a means for embodying the setup ramp voltage is selected and a method of connecting a variable resistance to a gate terminal of the second switch (S2) is considered.

It is preferable that the setup ramp supplier 72 further comprises the first diode (D1) connected between the one terminal of the first capacitor (C1) and the positive polarity terminal of the sustain pulse/setup bias/setup ramp/setdown pulse/scan pulse common voltage source (Vs).

By connecting an anode terminal of the first diode (D1) to the positive polarity terminal of the sustain pulse/setup bias/setup ramp/setdown pulse/scan pulse common voltage source (Vs) and a cathode terminal of the first diode (D1) to the one terminal of the first capacitor (C1), it is possible to intercept an inverse current from flowing from the one terminal of the first capacitor (C1) to the positive polarity terminal of the sustain pulse/setup bias/setup ramp/setdown pulse/scan pulse common voltage source (Vs).

The setdown pulse/scan pulse supplier 73 comprises a second capacitor (C2) charged by receiving power from the sustain pulse/setup bias/setup ramp/setdown pulse/scan pulse common voltage source (Vs), a fourth switch (S4) for converting a voltage charged in the second capacitor (C2) to a gradually falling setdown pulse voltage and supplying the converted voltage to the scan electrode (Y), and a fifth switch (S5) for using the voltage charged in the second capacitor (C2) to supply the scan pulse voltage to the scan electrode (Y).

One terminal of the second capacitor (C2) is connected to the other terminal of the first switch (S1) and the other terminal of the second capacitor (C2) is connected to the negative polarity terminal of the sustain pulse/setup bias/setup ramp/setdown pulse/scan pulse common voltage source (Vs). One terminal of the fourth switch (S4) and the fifth switch (S5) are commonly connected to the other terminal of the second capacitor (C2) and the other terminal of the fourth switch (S4) is connected to the other terminal of the fifth switch (S5).

An operation principle of the setdown pulse/scan pulse supplier 73 will be described in detail.

If the second and third terminals of the sustain pulse/setup bias supplier 71 are electrically connected through a switching operation within the sustain pulse/setup bias supplier 71 during the setdown period (SD) to form a network connecting the sustain pulse/setup bias/setup ramp/setdown pulse/scan pulse common voltage source (Vs), an inner diode of the first switch (S1), the second capacitor (C2), and the sustain pulse/setup bias/setup ramp/setdown pulse/scan pulse common voltage source (Vs), both terminals of the second capacitor (C2) are charged to a Vs level.

After both terminals of the second capacitor (C2) are charged to the Vs level, one terminal thereof turns on the fourth switch (S4) connected to the other terminal of the second capacitor (C2), that is, the negative polarity terminal of the second capacitor (C2).

If the fourth switch (S4) is turned on, a voltage of the Vs level charged in the second capacitor (C2) is converted to the setdown pulse voltage gradually falling by the fourth switch (S4) and the converted voltage is supplied to a second node (n2). A field effect diode (FET) as the fourth switch (S4) that is a means for embodying the setdown pulse voltage may be selected and a method of connecting a variable resistance to a gate terminal of the fourth switch (S4) may be considered.

If the fifth switch (S5) is turned on during the address period (AP), the scan pulse voltage of −Vs level is supplied to the second node through the fifth switch (S5).

It is preferable that the setdown pulse/scan pulse supplier 73 further comprises a second diode (D2) connected between the negative polarity terminal of the sustain pulse/setup bias/setup ramp/setdown pulse/scan pulse common voltage source (Vs) and the other terminal of the second capacitor (C2).

An anode terminal of the second diode (D2) is connected to the other terminal of the second capacitor (C2) and a cathode terminal of the second diode (D2) is connected to the negative polarity terminal of the sustain pulse/setup bias/setup ramp/setdown pulse/scan pulse common voltage source (Vs), so that an inverse current is prevented from flowing.

The scan reference voltage supplier 74 comprises a scan reference voltage source (Vsc) whose the negative polarity terminal is connected to the second node (n2), a sixth switch (S6) whose one terminal is connected to a positive polarity terminal of the scan reference voltage source (Vsc), and a seventh switch (S7) whose one terminal is connected to the other terminal of the sixth switch (S6) and whose other terminal is connected to the second node (n2). The sixth switch (S6) and the seventh switch (S7) are switched by a control signal supplied from the timing controller during the address period (AP) and supply a voltage of the scan reference voltage source (Vsc) to a scan IC 75 to be described later.

The scan IC 75 is connected in a push/pull manner and is composed of the sustain pulse/setup bias supplier 71, the setup ramp supplier 72, the setdown/scan voltage supplier 73, and an eighth switch (S8) and a ninth switch (S9) which supply various driving signals supplied from the scan reference voltage supplier 74 to the scan electrodes (Y). An output line between the eighth switch (S8) and the ninth switch (S9) is connected to any one among the scan electrode lines.

As described in detail above, according to the present invention, it is possible to provide a plasma display apparatus which can decrease the number of driving voltage sources by selecting and commonly using a voltage source supplying the sustain pulse voltage, the setup bias voltage, the setup ramp voltage, the setdown pulse voltage, and the scan pulse voltage among a plurality of driving voltages supplied to the scan electrode of the PDP and thus decrease the manufacturing costs.

The invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode; and
a scan driver comprising a common voltage source commonly using all of a setup bias voltage and a setdown pulse voltage applied during a reset period, a scan pulse voltage applied during an address period, and a sustain pulse voltage applied during a sustain period, to the scan electrode.

2. The plasma display apparatus of claim 1, wherein the scan driver comprises:
the common voltage source comprising one grounded terminal;
a sustain pulse/setup bias supplier connected between the common voltage source and the scan electrode to supply the sustain pulse voltage and the setup bias voltage to the scan electrode;
a setdown pulse/scan pulse supplier connected between the sustain pulse/setup bias supplier and the scan electrode to supply the setdown pulse voltage and the scan pulse voltage to the scan electrode; and
a first switch provided between the sustain pulse/setup bias supplier and the setdown pulse/scan pulse supplier.

3. The plasma display apparatus of claim 2, wherein a first terminal of the sustain pulse/setup bias supplier is commonly connected to negative polarity terminals of a ground voltage source and the sustain pulse/setup bias/setdown pulse/scan pulse common voltage source,
a second terminal of the sustain pulse/setup bias supplier is connected to a positive polarity terminal of the sustain pulse/setup bias/setdown pulse/scan pulse common voltage source, and
a third terminal of the sustain pulse/setup bias supplier is connected to one terminal of the first switch.

4. The plasma display apparatus of claim 2, wherein the setdown pulse/scan pulse supplier comprises:
a first capacitor charged by the common voltage source;
a fourth switch converting a voltage charged in the first capacitor to the setdown pulse voltage and supplying the converted voltage to the scan electrode; and
a fifth switch converting a voltage charged in the first capacitor to the scan pulse voltage and supplying the converted voltage to the scan electrode.

5. The plasma display apparatus of claim 4, wherein one terminal of the first capacitor is connected to the other terminal of the first switch, and
the other terminal of the first capacitor is connected to a negative terminal of the sustain pulse/setup bias/setdown pulse/scan pulse common voltage source.

6. The plasma display apparatus of claim 4, wherein one terminals of the fourth switch and the fifth switch are commonly connected to the other terminal of the first capacitor, and
the other terminal of the fourth switch is connected to the other terminal of the fifth switch.

7. The plasma display apparatus of claim 4, further comprising an inverse current preventing unit connected between the negative polarity terminal of the sustain pulse/setup bias/setdown pulse/scan pulse common voltage source and the other terminal of the first capacitor.

8. The plasma display apparatus of claim 7, wherein the inverse current preventing unit comprises a first diode, and
an anode terminal of the first diode is connected to the other terminal of the first capacitor and a cathode terminal of the first diode is connected to the negative terminal of the sustain pulse/setup bias/setdown pulse/scan pulse common voltage source.

9. The plasma display apparatus of claim 1, wherein the common voltage source further generates a setup ramp voltage supplied to the scan electrode.

10. A plasma display apparatus comprising:
a plasma display panel comprising a scan electrode; and
a scan driver comprising a common voltage source commonly using all of a setup bias voltage and a setup ramp voltage applied during a reset period and a sustain pulse voltage applied during a sustain period, to the scan electrode.

11. The plasma display apparatus of claim 10, wherein the scan driver comprises:
the common voltage source comprising one grounded terminal;
a sustain pulse/setup bias supplier connected between the common voltage source and the scan electrode to supply the sustain pulse voltage and the setup bias voltage to the scan electrode;
a setup ramp supplier connected between the sustain pulse/setup bias supplier and the scan electrode to supply the setup ramp voltage to the scan electrode; and
a first switch connected between the sustain pulse/setup bias supplier and the scan electrode.

12. The plasma display apparatus of claim 11, wherein a first terminal of the sustain pulse/setup bias supplier is commonly connected to negative polarity terminals of a ground voltage source and the sustain pulse/setup bias/setup ramp common voltage source,
a second terminal of the sustain pulse/setup bias supplier is commonly connected to a positive polarity terminal of the sustain pulse/setup bias/setup ramp common voltage source and a first terminal of the setup ramp supplier, and
a third terminal of the sustain pulse/setup bias supplier is commonly connected to a second terminal of the setup ramp supplier and one terminal of the first switch.

13. The plasma display apparatus of claim 11, wherein the setup ramp supplier comprises:
a first capacitor charged by the sustain pulse/setup bias/setup ramp common voltage source; and
a second switch converting a voltage charged in the first capacitor to the setup ramp voltage and supplying the converted voltage to the scan electrode.

14. The plasma display apparatus of claim 13, wherein one terminal of the first capacitor is commonly connected to the positive polarity terminal of the sustain pulse/setup bias/setup ramp common voltage source and the second terminal of the sustain pulse/setup bias supplier, and
the other terminal of the first capacitor is commonly connected to the third terminal of the sustain pulse/setup bias supplier and the one terminal of the first switch.

15. The plasma display apparatus of claim 13, wherein one terminal of the second switch is commonly connected to the positive polarity terminal of the sustain pulse/setup bias/setup ramp common voltage source, the second terminal of the sustain pulse/setup bias supplier, and the one terminal of the first capacitor, and
the other terminal of the second switch is connected to the other terminal of the first switch.

16. The plasma display apparatus of claim 13, further comprising an inverse current preventing unit connected between the positive polarity terminal of the sustain pulse/setup bias/setup ramp common voltage source and the one terminal of the first capacitor.

17. The plasma display apparatus of claim 16, the inverse current preventing unit comprises a first diode,
an anode terminal of the first diode is connected to the positive polarity terminal of the sustain pulse/setup bias/setup ramp common voltage source and a cathode terminal of the first diode is connected to the one terminal of the first capacitor.

18. A method of driving a plasma display apparatus driven by dividing a plurality of subfields into a reset period, an address period, and a sustain period, the method comprising:
supplying a setup pulse gradually rising to a setup voltage comprising the same voltage level as a setup bias voltage after rapidly rising to the setup bias voltage during a setup period of the reset period to a scan electrode; and
supplying a setdown pulse gradually falling from the setup bias voltage to a setdown voltage comprising the same absolute value as the setup bias voltage during a setdown period of the reset period to the scan electrode.

19. The method of claim 18, wherein an absolute voltage value of the scan pulse applied to the scan electrode is equal to the setup bias voltage level during the address period.

20. The method of claim 18, wherein a voltage of the sustain pulse applied to the scan electrode or the sustain electrode is equal to the setup bias voltage level during the sustain period.
